(19) United States
(12) Patent Application Publication
(10) Pub. No.: US 2011/0239758 A1
(43) Pub. Date: Oct. 6, 2011

(54) METHOD FOR OPTIMIZING THE SWITCHING BEHAVIOUR OF A VESSEL WARNING DEVICE OF AN EQUALIZING VESSEL AND EQUALIZING VESSEL FOR A HYDRAULIC MOTOR VEHICLE BRAKE SYSTEM HAVING A VESSEL WARNING DEVICE WITH OPTIMIZED SWITCHING

(76) Inventors: Johann Ludwig, Steinbach (DE); Hans-Jürgen Neumann, Russelsheim (DE); Peter Tandler, Kronberg (DE); Swen Ottmann, Frankfurt (DE); Christoph Schiel, Bad Nauheim (DE); Barbara Schmidt, Frankfurt/M (DE)

(21) Appl. No.: 12/682,833

(22) PCT Filed: Apr. 8, 2008
(86) PCT No.: PCT/EP08/54213

§ 371 Date: May 13, 2011

(30) Foreign Application Priority Data
Jul. 12, 2007 (DE) 1020070322521.7

(51) Int. Cl. H01H 36/02

(52) U.S. Cl. 73/308

(57) ABSTRACT

A method for optimizing the switching behaviour of a tank warning device of a compensation tank, in particular for a hydraulic motor-vehicle brake system, with a housing and the tank warning device for monitoring the tank filling level of the compensation tank. The tank warning device including a switching unit with a reed contact as a switching element, which can be switched by means of a magnet at a switching point S at which the switching unit generates a signal for an electronic control unit. A compensation tank including a tank warning device which has been optimized in terms of switching by means of a method according to the invention is also disclosed. The reed contact and the magnet are matched to one another in a manner optimized in terms of switching in such a way that the magnet switches at a single switching lobe of the reed contact.

### CROSS REFERENCE TO RELATED APPLICATIONS

This application is the U.S. national phase application of PCT International Application No. PCT/EP2008/054213, filed Apr. 8, 2008, which claims priority to German Patent Application No. 10 2007 032521.7, filed Jul. 12, 2007.

### FIELD OF THE INVENTION

The invention relates to a method for optimizing the switching behaviour of a tank warning device of a compensation tank and to a compensation tank.

### BACKGROUND OF THE INVENTION

In a hydraulic motor-vehicle brake system, the required brake fluid is situated in the compensation tank, the tank warning device for monitoring the tank filling level generally having a reed switch with a reed contact as a switching element and generally having a magnet as a transmitter. If the brake fluid level falls and the magnet passes a predetermined switching point, switching paddles of the reed switch close owing to the generated magnetic field since the magnetic force of attraction of the switching paddles exceeds the spring effect of the individual switching paddles. As described, the reed switch can be provided as a make contact or normally open switch, in which the switching paddles are open in the rest position. However, it is also possible to use a reed switch designed as a break contact or normally closed switch, which has switching paddles that are closed in the rest position and are opened under the action of a magnetic force.

This signal is evaluated in a control unit, and the driver of the motor vehicle can be warned by means of an optical and/or acoustic indication. At the same time, it is necessary to ensure that the compensation tank is always filled with a legally specified minimum of brake fluid to avoid jeopardizing the operation of the brake system. In general, use is made of tank warning devices for monitoring the tank filling level in which a float provided with the magnet switches the reed contact as soon as the float assumes a position (switching point) at which the tank filling level is below a defined minimum. The reed contact triggers a warning signal that can be recognized by the driver.

However, reed switches generally have a plurality of “switching lobes” (main and secondary lobes) which are distributed along a longitudinal axis of the reed switch and each of which represents a switching range or a switching point. The magnetically most sensitive switching point, referred to as the main lobe, is situated in the immediate vicinity of the reed switch. This switching point is usually used as the switching point for the tank warning device.

To ensure that the switching unit of the tank warning device switches only in the region of the main lobe, stops must be provided to limit the movement of the magnet precisely and reliably to prevent a switching process in the region of the secondary lobes, thereby ensuring the switching behaviour of the tank warning device in a defined manner. For this purpose, known compensation tanks—such as that known from DE 10 2005 009 657 A1, for example—have two stops, which are provided on one and the same component in order reliably to prevent a switching process in the region of the secondary lobes. According to DE 10 2005 009 657 A1, the stops are provided on the switching unit per se since the tank warning device is arranged in a cap of the compensation tank. If the tank warning device projects perpendicularly into the tank interior space in the region of the housing—the housing top part or the housing bottom part—the two stops are provided in the housing top part or in the housing bottom part. The complex and costly configuration of the known compensation tank due to the provision of the two stops on a single component, at least one of which stops must be positioned precisely, is considered to be disadvantageous.

### SUMMARY OF THE INVENTION

It is an object of the invention to provide a compensation tank which is improved in terms of the switching behaviour of the tank warning device and of costs.

The object is achieved by means of the method according to aspects of the invention for optimizing the switching behaviour of a tank warning device of a compensation tank, the method envisaging that the reed contact and the magnet be matched to one another in a manner optimized in terms of switching in such a way that the magnet switches at a single switching lobe of the reed contact. As a result, only the main lobe of the reed contact is effective, and the defined switching behaviour at the predetermined switching point can be ensured.

According to an advantageous embodiment of the method according to aspects of the invention, the magnetic flux density of the magnet and the switching sensitivity of the switching unit are matched to one another in a simple manner. It is thereby possible to dispense with precise positioning of the stops. A sensitivity range of the reed contact is preferably derived from the optimized switching sensitivity of the switching unit.

The above object is furthermore achieved by means of a compensation tank for a hydraulic motor-vehicle brake system with a housing comprising a housing top part and a housing bottom part and a tank warning device for monitoring the tank filling level of the compensation tank, comprising a switching unit with a plug connector and a contact carrier, which projects by means of one portion into a guide tube that projects into a tank interior space, and a reed contact as a switching element, which is arranged on the contact carrier in the region of the tank interior space and which can be switched by means of a magnet at a switching point at which the switching unit generates a signal for an electronic control unit, the magnet being arranged in a float which can be moved along the guide tube between two stops, the reed contact and the magnet thereof being matched to one another in a manner optimized in terms of switching, by one of the methods mentioned.

According to an advantageous embodiment, the magnet is provided as a plastic-bonded permanent magnet. This makes the magnet resistant to fracture, and spalling of the magnet can be avoided.

The magnet preferably has a magnetic flux density of about 14 mT, and a pull-in excitation of from 2.3 to 2.7 mT is provided for the switching unit, the switching unit having a pull-in excitation/dropout excitation hysteresis of from 120 to 145%. This provides a robust and functionally reliable switching unit since a shock-sensitive reed switch with a relatively high or a relatively low switching sensitivity and a magnet with a flux density that is too low or too high can be avoided.

To allow simpler and less costly production of the compensation tank, a first stop is arranged in the housing bottom part and a second stop is arranged in the housing top part.

### BRIEF DESCRIPTION OF THE DRAWINGS

The invention is best understood from the following detailed description when read in connection with the accompanying drawings. Included in the drawings is the following figures:

FIG. 1 shows the compensation tank according to aspects of the invention in plan view;

FIG. 2 shows a partially sectioned detail of the compensation tank according to aspects of the invention;

FIG. 3 shows a switching unit of the compensation tank according to aspects of the invention in longitudinal section;

FIG. 4 shows a further detail of the compensation tank according to aspects of the invention partially in longitudinal section;

FIG. 5 shows a known compensation tank in longitudinal section and

FIG. 6 shows a schematic representation of switching lobes of a reed switch.

### DETAILED DESCRIPTION OF THE PREFERRED EMBODIMENTS

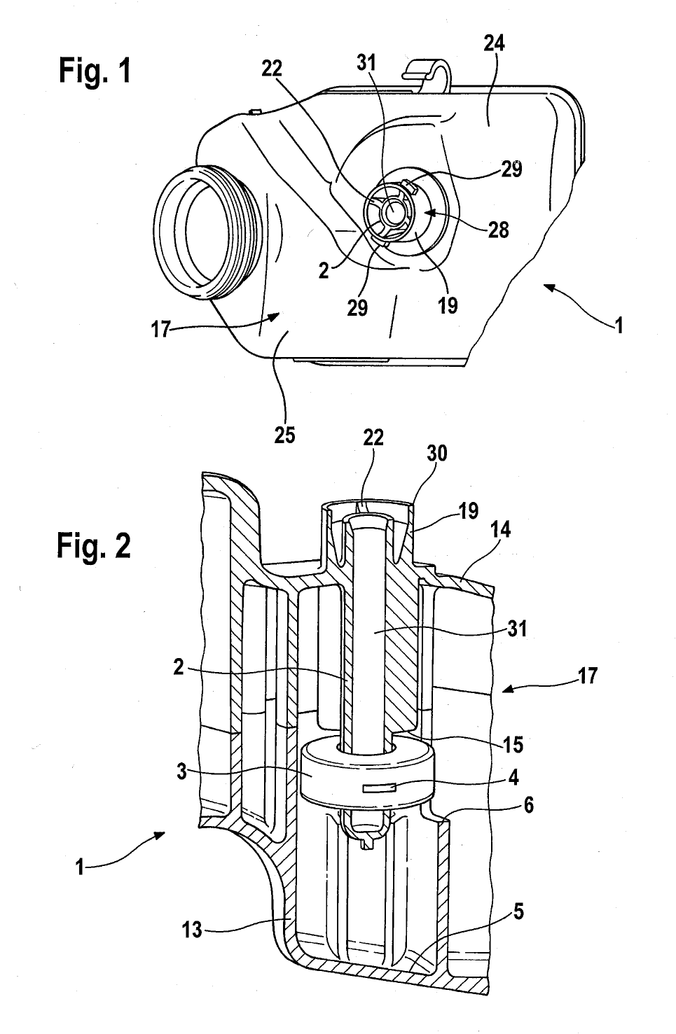

FIGS. 1 to 4 show a compensation tank 1 according to aspects of the invention, in some cases as a detail, the said compensation tank being attached to a master cylinder (not shown) of a vehicle brake system, for example. The compensation tank 1 has a guide tube 2, which projects into its interior and is closed at its end facing the interior of the tank.

As can be seen, in particular, from FIG. 2, which shows a partial detail of the compensation tank 1, a float 3, which is designed as a ring, for example, and forms part of a tank warning device for monitoring the tank filling level, is arranged in such a way that it can be moved along the guide tube 2, which has a circular cross-section, for example. The float 3 carries an annular magnet 4 as a magnetic transmitter. A first stop 6 rising from the bottom 5 of the compensation tank 1 limits the movement of the float 3 on the guide tube 2 in the direction of the bottom 5. This stop 6 defines the lowest position of the float 3 in the compensation tank 1 and prevents the float 3 from leaving the guide tube 2.

The compensation tank 1 is composed of a housing 17 comprising a housing bottom part 13 and a housing top part 14, which are welded together at their edges. As can be seen from FIG. 2, the first stop 6 for the float 3 is provided in the housing bottom part 13. A second stop 15 is arranged in the housing top part 14 in the region of the guide tube 2. As indicated in FIG. 4, the stop 15 is formed by a plurality of ribs arranged on the guide tube 2. Arranging the stops 6, 15 in different housing components makes the compensation tank 1 significantly simpler to produce.

The tank warning device for monitoring the tank filling level comprises a switching unit 7 with a contact carrier 9, which is provided in the interior of the guide tube 2 and to which a reed switch 8 with a reed contact as a switching element is attached. The switching unit 7 furthermore comprises a plug connector 10 with a housing 11 and, to facilitate assembly and simplify the production of the switching unit 7, can be constructed in one piece from a plastics material, as illustrated. Contact lugs 12, to which the reed switch 8 is attached, and other components, such as resistors, are provided in the contact carrier 9, being moulded in for example.

As soon as the magnet 4 passes a switching point S of the reed switch 8 owing to the tank filling level falling, switching paddles of the reed switch 8 close owing to the generated magnetic field of the magnet 4 since the magnetic force of attraction of the switching paddles exceeds the spring effect of the individual switching paddles. The reed switch 8 can be provided as a make contact or normally open switch, in which the switching paddles are open in the rest position. However, it is also possible to use a reed switch 8 designed as a break contact or normally closed switch, which has switching paddles that are closed in the rest position and are opened under the action of a magnetic force. The switching process generates a signal for an electronic switching unit of the motor-vehicle brake system.

The float 3 in this illustrative embodiment is provided in one piece and has a radial cutout, into which the annular magnet 4 is inserted. Side walls of the cutout are provided with holding means which secure the magnet 4 in its installation position. The magnet 4 is provided as a plastic-bonded permanent magnet, making the magnet 4 resistant to fracture and making it possible to avoid spalling of the magnet 4, which leads in the worst case to jamming of the float 3 on the guide tube 2.

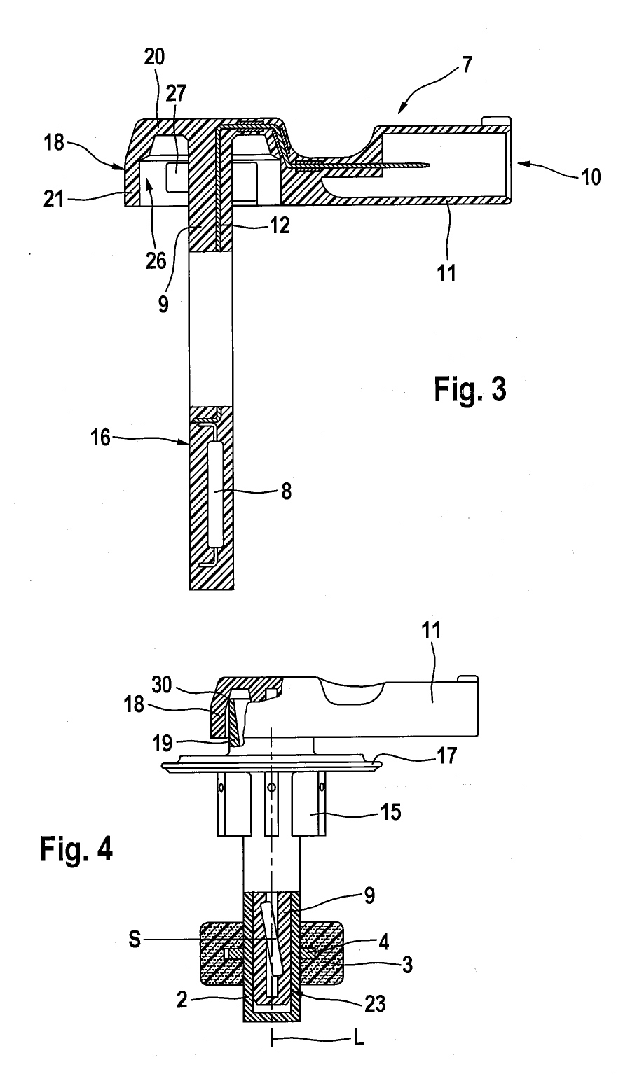

FIG. 3 shows the arrangement of the reed switch 8 only schematically. Thus it is conceivable to arrange the reed switch 8 in a recess in the contact carrier 9 and attach it to the contact lugs 12 therein. As an alternative, the reed switch 8 can be attached to a circuit board.

In order to protect the reed switch 8, it can be embedded in the material of the contact carrier 9, as illustrated in FIG. 3. For this purpose, the contact carrier 9 can be encapsulated with the same material in the region of the reed switch 8, for example, or a portion 16 of the contact carrier 9 which projects into a guide tube 2 of the compensation tank 1 can be enclosed after the attachment of the reed switch 8.

In order to permit releasable connection of the switching unit 7 to the housing 17 of the compensation tank 1, the contact carrier 9 has a pot-shaped portion 18 which interacts with an annular projection 19 formed on the housing 17. As can be seen, in particular, from FIG. 3, that portion 16 of the contact carrier 9 which carries the reed switch 8 extends centrally from an end 20 of the pot-shaped portion 18, and the housing 11 of the plug connector 10 is formed integrally on a wall 21 of the pot-shaped portion 18, perpendicularly to a longitudinal axis L of the switching unit 7.

FIG. 4 shows the partially sectioned switching unit 7 after installation in the housing 17 of the compensation tank 1. As is apparent, the guide tube 2 is provided concentrically within the annular projection 19, reinforcing ribs 22, which are illustrated in FIG. 1, being provided between the annular projection 19 and the guide tube 2 in order to reinforce the compensation tank 1 in the region of the annular projection 19.

Further stabilization of the switching unit 7 is ensured by means of a fit 23 in the interior of the guide tube 2—namely between the portion 16 of the contact carrier 9 and an inner side of the guide tube 2.

To optimize the packaging of the compensation tank 1, the annular projection 19 is arranged in a region 24 of the housing 17 which is provided in a position offset in the direction of the interior space of the tank in comparison with the remaining region 25 of the housing 17. Thus the switching unit 7 does not project beyond the housing 17 and cannot be obstructive either during transportation or in the installed condition of the compensation tank 1. The housing geometry shown furthermore makes it possible to prevent the switching unit 7 from being installed in an incorrect position—rotated by 180° in relation to the longitudinal axis L, for example.

A releasable connection between the contact carrier 9 and the encircling projection 19 can be configured as a bayonet joint, for example, comprising two diametrically opposite break-outs 27 with undercuts on an inner side 26 of the pot-shaped portion 18 and two diametrically opposite ribs 29 on an outer side 28 of the annular projection 19. This connection allows the switching unit 7 to be replaced in a simple manner without using a tool, while the undercuts prevent unintentional release of the connection. It is possible to provide different latching connections, such as a snap connection with resilient snap elements and corresponding elements for snapping in the snap elements.

The annular projection 19 is of resilient design and its edge 30 rests in a sealing manner against the inner side 26 of the pot-shaped portion 18. The annular projection 19 thus assumes a dual function since, on the one hand, the projection 19 protects an interior space 31 of the guide tube 2 against penetration by spray and, on the other hand, presses the break-outs 27 against the ribs 29 of the bayonet joint. The configuration of the ribs 29 and of the break-outs 27 determines the direction in which the switching unit 7 can be screwed in, and this takes place either anticlockwise until the bayonet joint latches in. The switching unit 7 is removed by pressing in the switching unit 7 against the edge 30 of the annular projection 19 and turning it clockwise or anticlockwise until the bayonet joint is released.

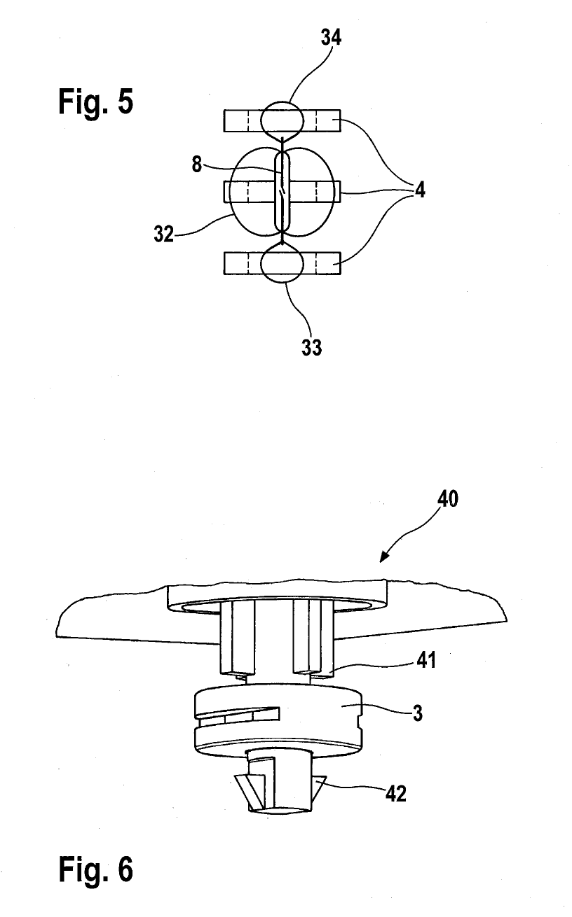

FIG. 5 shows the reed switch 8 with a plurality of characteristic switching lobes 32, 33, 34, which are distributed along a longitudinal axis of the reed switch 8 and which represent a switching range or a switching point S. The magnetically most sensitive switching point, referred to as the main lobe 32, is situated in the immediate vicinity of the reed switch 8. This switching point is usually used as switching point S for the tank warning device. As FIG. 5 shows, the main lobe 32 is adjoined by two secondary lobes 33, 34, which likewise form a switching point.

FIG. 6 shows a detail of a known compensation tank 40. As is apparent, the float 3 is arranged between two stops 41, 42, which are both provided on the housing top part. As described, it is necessary in the case of known compensation tanks to position the stops 41, 42 very close and very precisely to prevent a switching process in the region of the secondary switching lobes 33, 34. This results in a complex and costly configuration of the housing and/or of the switching unit.

In order to obtain a functionally reliable and robust switching unit 7 for the tank warning device while simultaneously reducing costs, the reed contact of the reed switch 8 and the magnet 4 are, according to aspects of the invention, matched to one another in a manner optimized in terms of switching in such a way that the magnet 4 switches at a single switching lobe of the reed contact, this being achieved by matching the magnetic flux density of the magnet 4 and the switching sensitivity of the switching unit 7 to one another. This means that only the main lobe 32 of the reed contact is effective, and the defined switching behaviour at the predetermined switching point S is assured, thereby making it possible to dispense with precise positioning of the stops 6, 15 or to dispense with the stops entirely.

It has proven advantageous if the magnet 4 has a magnetic flux density of about 14 mT, and a pull-in excitation of from 2.3 to 2.7 mT is provided for the switching unit 7, the switching unit 7 having a pull-in excitation/dropout excitation hysteresis of from 120 to 145%. This provides a robust and functionally reliable switching unit since a shock-sensitive reed switch 8 with a relatively high or a relatively low switching sensitivity and a magnet 4 with a flux density that is too low or too high can be avoided.

Once the pull-in excitation of the switching unit 7 has been determined, the corresponding sensitivity range of the reed contact can be derived from the optimized switching sensitivity of the switching unit 7.

The method according to aspects of the invention is not restricted to the configuration of the illustrative embodiment described of the compensation tank 1. In principle, any tank warning device could be designed in a manner optimized in terms of switching in the way described, irrespective of its construction. Thus the method can be applied to tank warning devices which are welded to the compensation tank 1 or latched releasably to it, or which are provided in a manner integrated into the screwed cap joint. Furthermore, it is not of decisive importance for the invention whether the reed contact and any resistors that are present are welded directly to the contact lugs 12 or to a circuit board.

1.-7. (canceled)

8. A method for optimizing the switching behaviour of a tank warning device for monitoring the tank filling level of a compensation tank with a housing and comprising a switching unit with a reed contact as a switching element, which can be switched by means of a magnet at a switching point (S) at which the switching unit generates a signal for an electronic control unit, wherein the reed contact and the magnet are matched to one another in a manner optimized in terms of switching in such a way that the magnet switches at a single switching lobe of the reed contact.

9. The method for optimizing the switching behaviour of a tank warning device according to claim 8, wherein the magnetic flux density of the magnet and the switching sensitivity of the switching unit are matched to one another.

10. The method for optimizing the switching behaviour of a tank warning device according to claim 9, wherein a sensitivity range of the reed contact is derived from the optimized switching sensitivity of the switching unit.

11. A compensation tank for a hydraulic motor-vehicle brake system with a housing comprising a housing top part and a housing bottom part, and
a tank warning device for monitoring the tank filling level of the compensation tank, comprising a switching unit with a plug connector and a contact carrier, which projects by means of a portion into a guide tube that projects into a tank interior space,
and a reed contact as a switching element, which is arranged on the contact carrier in the region of the tank interior space and which can be switched by means of a magnet at a switching point (S) at which the switching unit generates a signal for an electronic control unit, the magnet being arranged in a float which can be moved along the guide tube between two stops,
wherein the reed contact and the magnet are matched to one another in a manner optimized in terms of switching in such a way that the magnet switches at a single switching lobe of the reed contact.

12. The compensation tank according to claim 11, wherein the magnet is provided as a plastic-bonded permanent magnet.

13. The compensation tank according to claim 11, wherein the magnet has a magnetic flux density of about 14 mT, and a pull-in excitation of from 2.3 to 2.7 mT is provided for the switching unit, the switching unit having a pull-in excitation/dropout excitation hysteresis of from 120 to 145%.

14. The compensation tank according to claim 11, wherein a first stop is arranged in the housing bottom part and a second stop is arranged in the housing top part.
